(19) United States
(12) Patent Application Publication
(10) Pub. No.: US 2019/0386928 A1
(43) Pub. Date: Dec. 19, 2019

(54) SYSTEM AND METHOD FOR UTILIZING IDLE NETWORK RESOURCES

(71) Applicant: R-Stor Inc., Saratoga, CA (US)

(72) Inventors: George Yakovlev, Pacifica, CA (US); Damian Kowalewski, Sunnyvale, CA (US)

(21) Appl. No.: 16/437,490

(22) Filed: Jun. 11, 2019

Related U.S. Application Data
(60) Provisional application No. 62/687,121, filed on Jun. 19, 2018.

(51) Int. Cl. H04L 12/911; H04L 12/24

(52) U.S. Cl. CPC H04L 47/78; H04L 41/0893; H04L 41/0896; H04L 41/0266

(57) ABSTRACT

Systems and apparatus for utilizing idle resources in a computer network and methods for making and using the same. In various embodiment, these technologies are used to maximize computer network utilization by monitoring and reporting the availability of selected network resources among other things.

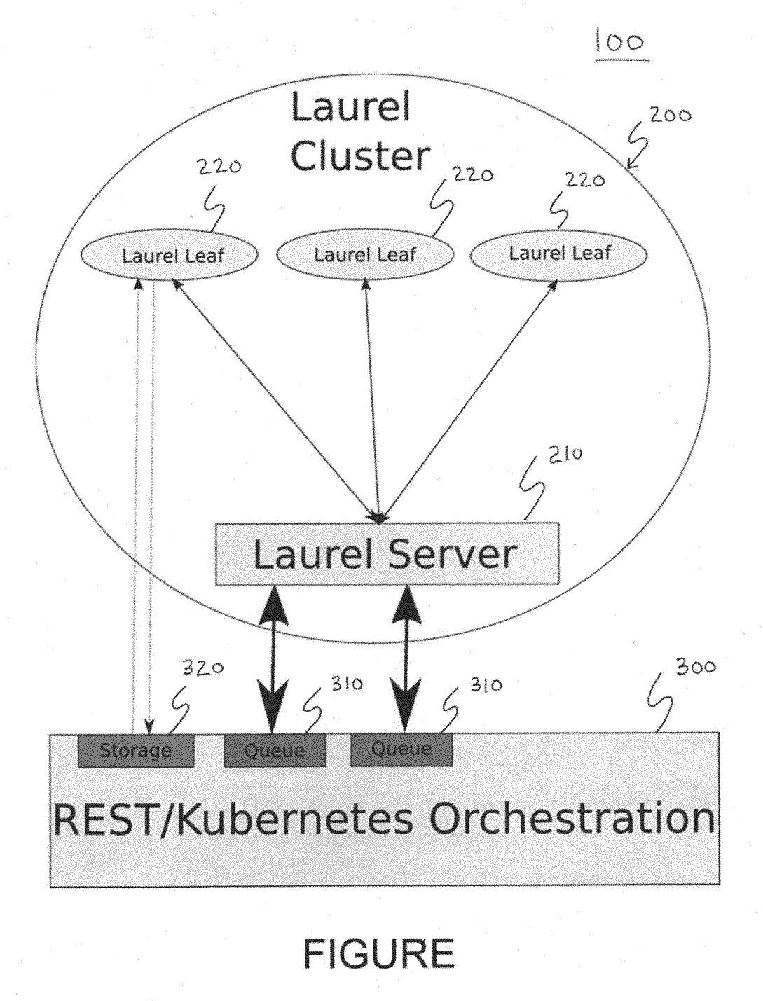

### CROSS-REFERENCE TO RELATED APPLICATIONS

This application claims the benefit of, and priority to, U.S. Provisional Application Ser. No. 62/687,121, filed Jun. 19, 2018, the disclosure of which is hereby incorporated herein by reference in its entirety and for all purposes.

### FIELD

The present disclosure relates generally to network resource allocation and more particularly, but not exclusively, to systems and methods for utilizing idle resources in a computer network.

### BACKGROUND

Conventional computer networks comprise a plurality of interconnected servers, computers and other network components. The various network components can communicate in a wired and/or wireless manner. As a part of this communication, data is exchanged among the network components typically via data packets in accordance with a communication protocol standard, such as Transmission Control Protocol (TCP) and/or User Datagram Protocol (UDP). The same communication protocol standard is used to transmit the data packets as the data packets traverse the computer network from a source network component to a destination network component.

Processing of network data, however, can become very inefficient when all network resources are not fully utilized. In some cases, one or more network resources can become idle. In this situation, valuable network resources of the computer network are being wasted by the unused/idle network resources and there may not be enough remaining resources to fully process the available network data. Conventional methods of detecting idle network resources include monitoring processor usage and storage device input/output operations such as via a heartbeat feature that periodically executes a message signal procedure that requires processor usage and input/output operations. Such conventional methods, however, would not detect some network resources as being idle when the network resource periodically initiates processor usage and input/output operations.

In view of the foregoing, a need exists for an improved system and method for utilizing idle resources in a computer network in an effort to overcome the aforementioned obstacles and deficiencies of conventional computer networks.

### BRIEF DESCRIPTION OF THE DRAWING

The FIGURE is an exemplary top-level drawing illustrating an embodiment of a network resource allocation system for utilizing idle resources in a computer network.

It should be noted that the FIGURE is not drawn to scale and that elements of similar structures or functions are generally represented by like reference numerals for illustrative purposes throughout the FIGURE. It also should be noted that the FIGURE is only intended to facilitate the description of the preferred embodiments. The FIGURE does not illustrate every aspect of the described embodiments and do not limit the scope of the present disclosure.

### DETAILED DESCRIPTION

Since currently-available computer networks may not accurately detect some network resources as being idle, a network resource allocation system that can utilized idle resources in a computer network can prove desirable and provide a basis for a wide range of computer applications. This result can be achieved, according to one embodiment disclosed herein, by a network resource allocation system 200 as illustrated in the FIGURE.

Turning to the FIGURE, the network resource allocation system 200 is shown as being installed within a computer network 100. The computer network 100 can comprise any type of conventional computer network. Exemplary network types can include a Local Area Network (LAN), a Wide Area Network (WAN), a Wireless Local Area Network (WLAN), a Metropolitan Area Network (MAN) and/or a Campus Area Network (CAN) without limitation. In one embodiment, the computer network 100 can include a set of one or more interconnected servers, computers, network components and other network resources. The network resource allocation system 200 can be provided as an agent for the computer network 100 and advantageously can allow usage of one or more idle network (or computing) resources (not shown) of the computer network 100.

As illustrated in the FIGURE, the network resource allocation system 200 can include a network resource allocation server 210 and at least one instance of network resource allocation software 220. The network resource allocation server 210 can comprise one or more computers and/or computer programs for managing access to the network resources of the computer network 100. Being configured to communicate with an orchestration system (or software) 300, the network resource allocation server 210 can be enabled to operate as a resource manager for the instances of network resource allocation software 220. Although shown and described as comprising one network resource allocation server 210 and three instances of network resource allocation software 220 for purposes of illustration only, the network resource allocation system 200 can include any suitable number of network resource allocation servers 210 and any predetermined number of instances of the network resource allocation software 220.

In one embodiment, the network resource allocation server 210 can manage a selected queue 310 of the orchestration system 300. The selected queue 310 preferably is a queue 310 of the orchestration system 300 that is dedicated for use by the network resource allocation server 210. The network resource allocation server 210, for example, can receive one or more jobs from the orchestration system 300 via the selected queue 310. Upon extracting metadata from the received jobs, the network resource allocation server 210 can push the jobs and/or the metadata to the active instances of network resource allocation software 220 for processing. When processing of the jobs and/or the metadata is complete, the network resource allocation server 210 can receive results metadata for the processed jobs and/or metadata from the active instances of network resource allocation software 220 and provide the results metadata to the orchestration system 300 via the selected queue 310. The jobs thereby can be updated by the orchestration system 300 based upon the results metadata.

The network resource allocation server 210, additionally and/or alternatively, can control operation of the network resource allocation software 220. For example, the network resource allocation server 210 can provide peer information for the network resource allocation software 220. In one embodiment, the network resource allocation software 220 can utilize the peer information to connect a selected instance of network resource allocation software 220 with one or more other instances of network resource allocation software 220, as desired.

Optionally, the network resource allocation server 210 can update the orchestration system 300. An exemplary update can include the network resource allocation server 210 providing updated queue metadata to the orchestration system 300. The updated queue metadata, for example, can include updated information on the availability of selected network resources of the computer network 100. In one embodiment, the updated queue metadata can include the updated availability information for each network resource of the computer network 100. The orchestration system 300 thereby can make informed decisions for operating the selected queue 310 based upon the updated availability information.

In one embodiment, the network resource allocation software 220 can be provided as an agent for execution via the one or more computer systems of the computer network 100. Each instance of the network resource allocation software 220 preferably is associated with a predetermined network resource allocation server 210. If the network resource allocation system 200 includes more than one network resource allocation server 210, for example, each instance of the network resource allocation software 220 can have an account with only one of the predetermined network resource allocation servers 210.

In operation, the network resource allocation software 220 can support a wide variety of functions for the computer network 100. The network resource allocation software 220 can check the availability of one or more of the network resources of the computer network 100. The availability check can be performed based upon one or more predetermined criteria. The network resource allocation software 220 can check network resource availability, for example, based upon a preselected day/time schedule and/or physical availability of the network resources. Exemplary criteria for determining the physical availability of a selected network resource can include, but are not limited to, central processing unit (CPU) load, available hard disk space, available memory, thermals, etc.

Upon determining that a selected network resource is available, the network resource allocation software 220 can announce itself to the network resource allocation server 210. The network resource allocation software 220 then can receive one or more jobs and/or the related job metadata pushed to the network resource allocation software 220 by the network resource allocation server 210.

The network resource allocation software 220 optionally can retrieve any files needed for processing the pushed jobs and/or job metadata from the orchestration system 300. In one embodiment, the needed files can be stored at, and/or directly available to the network resource allocation software 220 from, a storage system 320 of the orchestration system 300. Upon retrieving the needed files, the network resource allocation software 220 can process the retrieved files. The network resource allocation software 220, for example, can unpack and/or verify the retrieved files, as needed.

The network resource allocation software 220 can process the pushed jobs. Processing the pushed jobs can include creation of one or more output files. The network resource allocation software 220 can transmit the output files to the orchestration system 300. The output files preferably are directly received from the network resource allocation software 220 and are stored in the storage system 320 of the orchestration system 300. Additionally and/or alternatively, network resource allocation software 220 can transmit the results metadata for the processed jobs to the network resource allocation server 210. In one embodiment, the network resource allocation software 220 likewise can include report logs and/or metrics for the processed jobs to the network resource allocation server 210.

If the selected network resource is available after transmitting the results metadata, the network resource allocation software 220 can again announce itself to the network resource allocation server 210 and the above process can be repeated for one or more new jobs.

Although various implementations are discussed herein and shown in the FIGURE, it will be understood that the principles described herein are not limited to such. For example, while particular scenarios are referenced, it will be understood that the principles described herein apply to any suitable type of computer network, including, but not limited to, a Local Area Network (LAN), a Wide Area Network (WAN), a Wireless Local Area Network (WLAN), a Metropolitan Area Network (MAN) and/or a Campus Area Network (CAN).

Accordingly, persons of ordinary skill in the art will understand that, although particular embodiments have been illustrated and described, the principles described herein can be applied to different types of computer networks. Certain embodiments have been described for the purpose of simplifying the description, and it will be understood to persons skilled in the art that this is illustrative only. It will also be understood that reference to a “server,” “computer,” “network component” or other hardware or software terms herein can refer to any other type of suitable device, component, software, and so on. Moreover, the principles discussed herein can be generalized to any number and configuration of systems and protocols and can be implemented using any suitable type of digital electronic circuitry, or in computer software, firmware, or hardware. Accordingly, while this specification highlights particular implementation details, these should not be construed as limitations on the scope of any invention or of what may be claimed, but rather as descriptions of features that may be specific to particular embodiments of particular inventions.

What is claimed is:

1. A method for utilizing idle network resources in a computer network, comprising:
determining an availability of one or more network resources of the computer network;
identifying a selected network resource as being available;
receiving and processing one or more jobs and related metadata at the selected network resource; and
creating at least one output file from the processed jobs and related metadata via the selected network resource.

2. The method of claim 1, wherein said determining the availability, said identifying the selected network resource, said receiving and processing the one or more jobs and related metadata and said creating the at least one output file are performed via network resource allocation software.

3. The method of claim 2, wherein said identifying the selected network resource includes announcing the network resource allocation software to a network resource allocation server, and wherein said receiving the one or more jobs and related metadata includes receiving the one or more jobs and related metadata from the network resource allocation server.

4. The method of claim 3, further comprising retrieving at least one file from the network resource allocation server, wherein said processing the one or more jobs and related metadata includes processing the at least one file.

5. The method of claim 4, wherein said processing the one or more jobs and related metadata includes unpacking the at least one file, verifying the at least one file or both.

6. The method of claim 4, wherein said retrieving the at least one file includes retrieving the at least one file from an orchestration system in communication with the network resource allocation server.

7. The method of claim 6, further comprising transmitting the at least one output file to the orchestration system.

8. The method of claim 7, further comprising determining an availability of the selected network resource after said transmitting the at least one output file and, upon identifying that the selected network resource is available, receiving and processing one or more new jobs and related metadata at the selected network resource and creating at least one output file from the processed new jobs and related metadata via the selected network resource.

9. The method of claim 1, wherein said determining the availability includes determining the availability of the network resources based upon one or more predetermined criteria.

10. The method of claim 9, wherein the predetermined criteria include a preselected schedule, a physical availability of the network resources or both.

11. A computer program product for utilizing idle network resources in a computer network, the computer program product being encoded on one or more non-transitory machine-readable storage media and comprising:
instruction for determining an availability of one or more network resources of the computer network;
instruction for identifying a selected network resource as being available;
instruction for receiving and processing one or more jobs and related metadata at the selected network resource; and
instruction for creating at least one output file from the processed jobs and related metadata via the selected network resource.

12. A network resource allocation system for utilizing idle network resources in a computer network, comprising:
a network resource allocation server for managing access to one or more network resources of the computer network; and
one or more instances of network resource allocation software,
wherein said network resource allocation server is enabled to operate as a resource manager for said instances of the network resource allocation software.

13. The network resource allocation system of claim 12, wherein said instances of the network resource allocation software determine an availability of the network resources of the computer network.

14. The network resource allocation system of claim 12, wherein said network resource allocation server controls operation of said instances of the network resource allocation software by providing peer information for the network resource allocation software, and wherein said instances of the network resource allocation software utilize the peer information to connect a first selected instance of the network resource allocation software with one or more other selected instances of the network resource allocation software.

15. The network resource allocation system of claim 12, further comprising a plurality of network resource allocation servers, wherein each of said instances of the network resource allocation software is associated with a respective network resource allocation server.

16. The network resource allocation system of claim 12, wherein at least one instance of the network resource allocation software is provided as an agent for execution via one or more computer systems of the computer network.

17. The network resource allocation system of claim 12, wherein said network resource allocation server is in communication with an orchestration system and manages a selected queue of the orchestration system.

18. The network resource allocation system of claim 17, wherein the selected queue of the orchestration system is dedicated for use by said network resource allocation server.

19. The network resource allocation system of claim 17, wherein said network resource allocation server receives one or more jobs from the orchestration system via the selected queue, extracts metadata from the received jobs and pushes the received jobs and the metadata to an active instance of the network resource allocation software, wherein the active instance of the network resource allocation software processes the pushed jobs and metadata to generate processed metadata and provides the processed metadata to said network resource allocation server, wherein said network resource allocation server provides the processed metadata to the orchestration system via the selected queue, and wherein the orchestration system updates the jobs based upon the processed metadata.

20. The network resource allocation system of claim 17, wherein said network resource allocation server updates the orchestration system by providing the orchestration system with updated queue metadata that includes updated availability information for selected network resources of the computer network, the updated queue metadata enabling the orchestration system to make informed decisions for operating the selected queue based upon the updated availability information.
